(19) United States
(12) Patent Application Publication
(10) Pub. No.: US 2015/0066985 A1
(43) Pub. Date: Mar. 5, 2015

(54) RETRIEVING INFORMATION FROM SOCIAL MEDIA SITES BASED UPON EVENTS IN AN ENTERPRISE

(71) Applicants: ANTONY RAJA T, Bangalore (IN); Samual Krish R, Chennai (IN)

(72) Inventors: ANTONY RAJA T, Bangalore (IN); Samual Krish R, Chennai (IN)

(21) Appl. No.: 14/010,535

(22) Filed: Aug. 27, 2013

(51) Int. Cl. G06F 17/30

(52) U.S. Cl. CPC G06F 17/30864
USPC 707/779

(57) ABSTRACT

Various embodiments of systems and methods for retrieving information from social media sites based upon an event in an enterprise are described herein. In one aspect, the method includes receiving an event trigger indicating an occurrence of an event. The event trigger is received when an event condition comprising one or more business parameters and their corresponding value is met. Based upon the received event trigger, the one or more parameters and their corresponding value are retrieved. A watchpoint for the event is generated based upon the retrieved parameters and their values. The information on the watchpoint is retrieved from one or more social media sites. The retrieved information is displayed on one or more computing devices. In one embodiment, the retrieved information is arranged in a predefined format and then displayed on the one or more computing devices.

### BACKGROUND

Business planning and performance monitoring has become extremely important in today's business marketplace for making optimized operational plans and decisions. Also, enterprises such as banks, corporations, manufacturing companies and service providing companies have a need to monitor the performance of their products/services from the standpoint of their customers or end users. However, the process of gathering and monitoring such business information requires lots of resources. The conventional data gathering method may consist of various sources which do not provide business information from the consumer's standpoint. The business information collected from various sources are often disjoined, requiring manual assembly into a format that is suitable to users or other consumers of such information.

Further, certain developments in the socio-economic conditions surrounding an enterprise may require changes to business operations performed in the enterprise. In order to effect such changes, current business performance information and other statistical data may need to be gathered and analyzed. However, the business information gathering process may not be initiated unless explicitly directed, leading to untimely planning and execution of operations.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system for retrieving business related information from social media sites based upon events in an enterprise, according to an embodiment.

FIG. 2 is a block diagram of an event subscription tool coupled to a pattern capturing system, according to an embodiment.

FIG. 3 illustrates an exemplary graphical user interface showing an event template creation process by an event subscription tool, according to an embodiment.

FIG. 4 is a block diagram illustrating an exemplary event template, according to an embodiment.

FIG. 5 shows an exemplary watchpoint generated by an information retrieving tool, according to an embodiment.

FIG. 6 is a block diagram of an exemplary system for retrieving business related information from social media sites, according to an embodiment.

FIG. 7 is a flow chart of a process for retrieving information from social media sites based upon events in an enterprise, according to an embodiment.

FIG. 8 is a block diagram of an exemplary computer system, according to an embodiment.

### DESCRIPTION

Embodiments of techniques for retrieving business related information from social media sites based upon events in an enterprise are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, an event may be any observable business-related occurrence. For example, an observable decrease in sales rate of a product within an enterprise is an event. In an aspect, a condition for detecting an event is defined using an event template. An “event template” as used herein is a statement having a predefined text and one or more place holders. A place holder holds the place for a variable such as a business parameter. For example, a place holder may represent a business parameter such as product name (e.g., ‘ProductName’), fiscal period (e.g., ‘FiscalPeriod’), sales revenue (e.g., ‘SalesRevenue’), threshold value of decrease in sales of a product (e.g., ‘ThresholdValue’), etc. An event condition is created by providing values corresponding to the business parameters represented by each of the place holders in the event template. For example, for the ‘ProductName’ may be provided ‘LG® television’ value. In another aspect, the event template is selected from a list of templates archived in a database or a storage location. The event template is selected according to the event that a user wants to be detected. For example, a sales manager may select a sales event template to create an event condition such as “a decrease in sales rate in last 3 months.” An event trigger is then setoff upon detecting an actual decrease in sales rate in the last 3 months. In yet another aspect, the user may provide values for the parameters at runtime and an event is detected based on the provided values.

In an embodiment, the place holders for the parameters from various event templates are consolidated into one or more patterns. The term “pattern” as used herein refers to a collection of variables or parameters from one or more event templates. For example, a pattern may be formed by a combination of parameters such as product name and threshold. Another pattern may be formed by a combination of parameters such as product name, threshold, and timeline. When an event template is created for the first time, a pattern may be generated based on the parameters in the created event template. However, in the instance where less than all of the parameters in the template are assigned a value, a system may automatically create a pattern having a combination of only those parameters that are assigned a value. For example, a user may want to create an event condition using less than of the parameters predefined in an event template. The user may then create the event condition by assigning values to only those parameters of interest to the user and represented by the place holders in the template. For example, when the user provides value only for the parameter ‘product name’ of the sales event template having parameters ‘product name,’ ‘threshold %,’ and ‘timeline’ then a pattern just comprising the parameter ‘product name’ is created.

In an embodiment a pattern is used to enhance an event template. For example, a user may want to add additional parameters to those already provided by an existing event template. In order to add additional parameters for creating an event condition, the user has to simply select a pattern having the required parameter or combination of parameters. The system automatically generates an enhanced template having additional parameters from the selected pattern.

Upon creation of an event condition using an event template, the event condition may be provided to an event monitoring tool. The event monitoring tool monitors business data sources such as databases, analytics tools, reports, etc., to determine whether the event condition is met. Upon detecting that the event condition is met, an event trigger is set off and the event template is sent to an information retrieving tool. The information retrieving tool creates a ‘watchpoint’ based on the parameters in the event template. The term “watchpoint” as used herein is defined as a collection of search strings used for searching social media to extract business information related to the event. For example, the search strings are formed using the values assigned to the parameters in the event template. In an embodiment, the search strings are linked using logical or search operators such as ‘and,’ ‘with,’ ‘next to,’ ‘or,’ etc. The values for some of the parameters in the event template may not be assigned by a user, in such instances, the missing values may be automatically retrieved from one or more databases within an enterprise. For example, some databases within the enterprise may hold detailed business information related to a product or a service, such as, product manager, sales manager, product sales, etc. Further, the search strings in the watchpoint may be formed using parameters from a pattern database in addition to the parameters from the event template. Based upon the created watchpoint, the information retrieving tool searches social media. sites and retrieves business information.

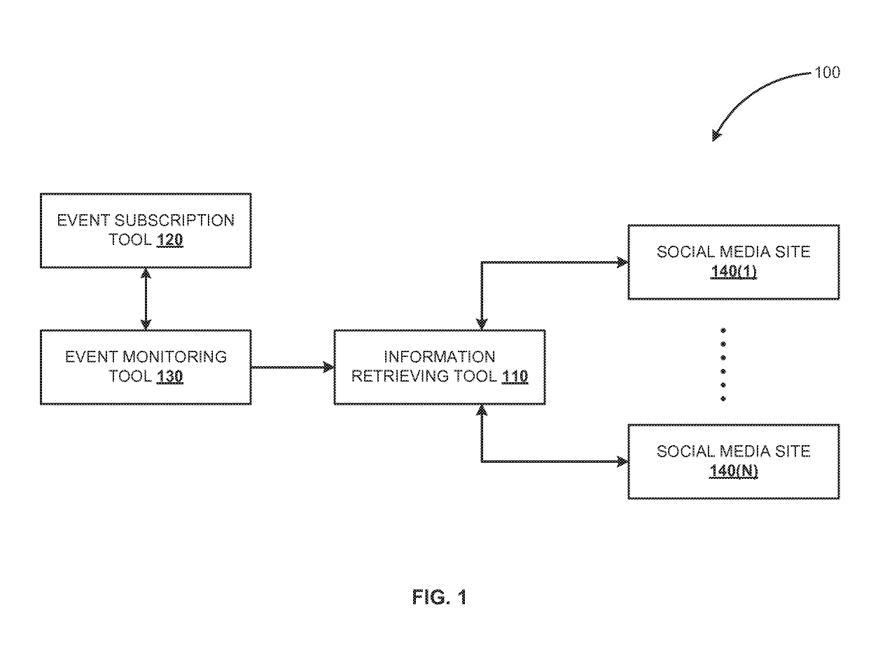

FIG. 1 illustrates system 100 including information retrieving tool 110 for retrieving information from social media sites 140(1)-140(N) based upon an event in an enterprise (not shown). The system 100 further includes event subscription tool 120 coupled to event monitoring tool 130 which in turn is communicatively coupled to the information retrieving tool 110. The information retrieving tool 110 is in turn communicatively connected to social media sites 140(1) to 140(N). In an aspect, the event subscription tool 120 creates an event condition using an event template. in one embodiment, the event condition is created by assigning the values for the placeholders in the event template. The created event condition is then provided as input to the event monitoring tool 130. In another aspect, the event monitoring tool 130 monitors the various business processes and business data sources within the enterprise to determine an event as defined by the event condition. When an event occurs, the event monitoring tool 130 set off an event trigger and sends the event template to the information retrieving tool 110. Once the event trigger is received by the information retrieving tool 110, the information retrieving tool 110 retrieves the values assigned to the parameters in the event condition. Based upon the retrieved values for the parameters, the information retrieving tool 110 generates a watchpoint for the event. The watchpoint is a combination of search strings used for searching social media sites to extract business information related to the event. The search strings may be formed using the values assigned to the place holders in the event template. In an embodiment, the search strings are linked using search operators such as ‘and,’ ‘with,’ ‘next to,’ ‘or,’ etc. Based upon the generated watchpoint, the information retrieving tool 110 retrieves information from the social media sites 140(1)-140(N). The retrieved information can be analyzed for the purposes of the enterprise.

The enterprise may be any organization or association involved in business transactions. The enterprise involves execution of various business processes, e.g., manufacturing process, sales, etc. Process owners are responsible for their respective processes within the enterprise. For example, a sales manager is a process owner responsible for sales. Information related to each process or business data are maintained in business data sources such as database tables, reports, analytical tools, etc. In an embodiment, the business data sources may be on a server. In another embodiment, the business data sources may be on corresponding process owner system. The business data sources may be updated automatically in real time. For example, the business data sources may he updated in real time based upon the execution of the business processes within the enterprise.

The process owners may be interested in observing critical issues related to their corresponding process. For example, the sales manager may be interested in detecting a condition where a sales rate for a product is going down. The process owner defines the event template slating the situation that the process owner wants to detect. For example, the sales manager may define a sales event template for triggering a sales event when the sales rate goes down.

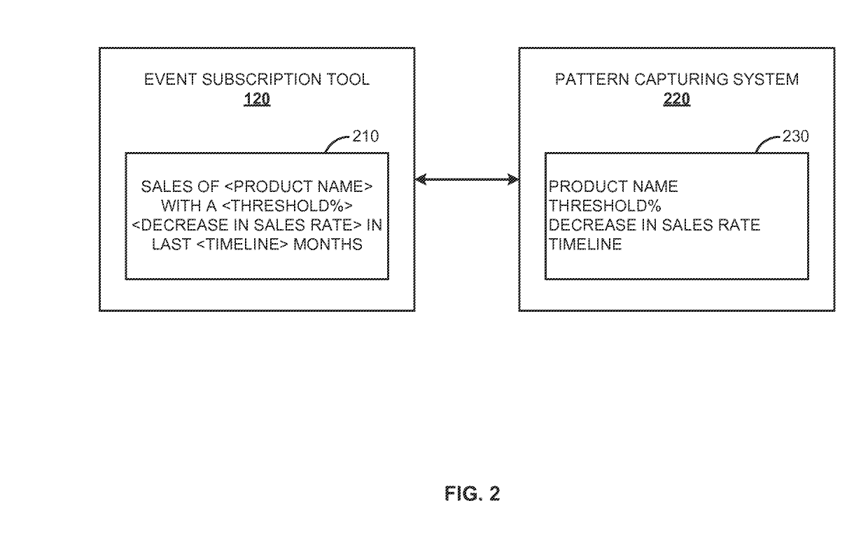

Referring to FIG. 2, the event subscription tool 120 is used for defining the event templates. The process owner defines the event template for detecting the occurrence of an event. For example, the sales manager may define an event such as ‘the decrease in sales rate’ using a sales event template 210. The sales event template 210 includes various parameters or placeholders such as ‘product name,’ ‘threshold %,’ ‘decrease in sales rate’ and ‘timeline.’ As shown, the parameters are represented by the place holders included between symbols ‘<’ and ‘>’. The values for the parameters may be provided by the sales manager at runtime. Once the sales event template 210 is created and stored in the event subscription tool 120, a pattern capturing system 220 creates a pattern 230 corresponding to the sales event template 210.

The pattern 230 comprises parameters included within the sales event template 210. For example, the pattern 230 comprises ‘product name,’ ‘threshold %,’ ‘decrease in sales rate’ and ‘timeline.’ The pattern 230 is stored in the pattern capturing system 220. In an embodiment, the pattern capturing system 220 is communicatively coupled to the event subscription tool 120. In an alternate embodiment, the pattern capturing system 220 is internal to the event subscription tool 120. When an event template is created, the pattern capturing system 220 creates a pattern corresponding to the event template. In one embodiment, the pattern capturing system 220 looks for terms within specific symbols, e.g., ‘< >’ in the event template, and includes those terms in the corresponding pattern. For example, the pattern capturing system 220 looks for the terms surrounded by symbols ‘<’ and ‘>’ in the sales event template 210 “Sales of <product name> with a <threshold %> <decrease in sales rate> in last <timeline> months,” and extracts the terms, ‘product name,’ ‘threshold %,’ ‘decrease in sales rate’ and ‘timeline,’ in the pattern 230. In one embodiment, the pattern capturing system 220 classifies and stores the patterns related to a particular business category together. For example, patterns related to ‘sales’ may be stored under sales category.

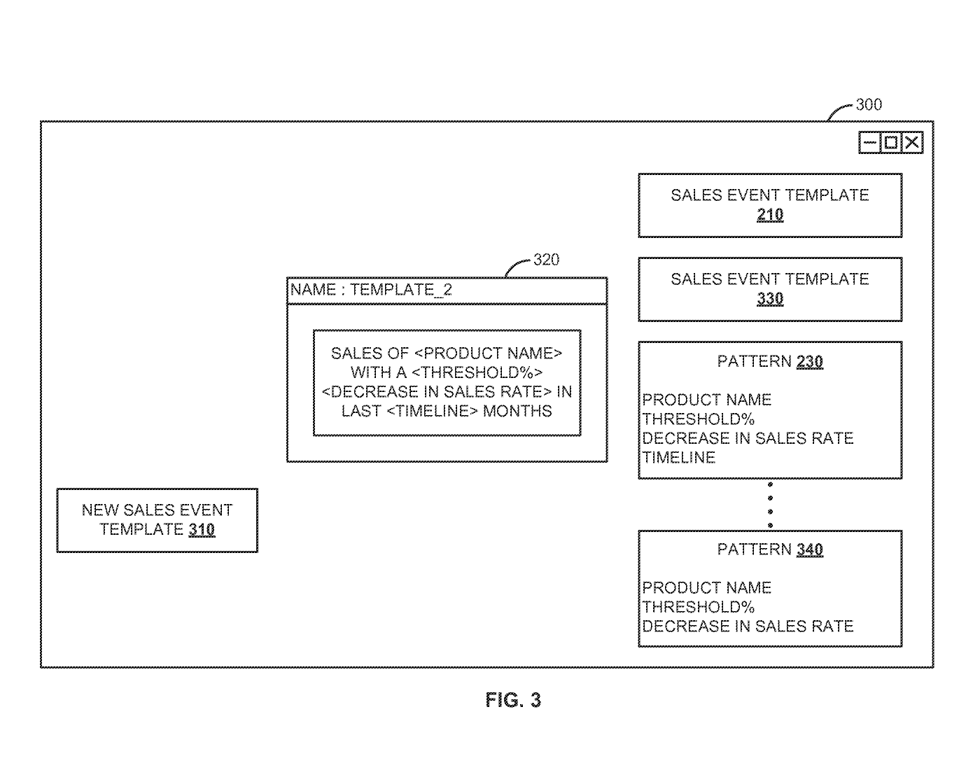

In one embodiment, the stored patterns and the stored templates are displayed to the user. The event subscription tool 120 may display the stored patterns and the templates to the user when the user tries to create a new event template. In one embodiment, the event subscription tool 120 retrieves the stored patterns from the pattern capturing system 220 and displays it to the user. FIG. 3 shows a graphical user interface (GUI) 300 for creating event templates. In an embodiment, a new sales event template is created by selecting the icon ‘new sales event template’ 310 of the GUI 300.

Upon receiving a selection of the icon ‘new sales event template’ 310 the event subscription tool 120 displays the stored event templates and patterns related to sales. For example, the event subscription tool 120 displays the already stored sales event template 210 and 330 on the GM 300 as selectable options. In one embodiment, the event subscription tool 120 retrieves all patterns related to sales from the pattern capturing system 220 and display it to the user. For example, the event subscription tool 120 retrieves the patterns 230 and 340 from the pattern capturing system 220 and displays it in the GM 300 as e.g., user-selectable options.

For example, upon receiving a selection of the sales event template 210, a template area 320 is populated with the content of the selected sales event template 210. In an aspect, the content of the event template 210 rendered in the template area 320 can be dynamically modified according to specific requirements. For example, a parameter, e.g., ‘IN LAST <TIMELINE> MONTHS’ may be removed from the content of the event template 210. Alternatively additional parameters may be added to the content of the rendered event template 210 in the template area 320. The modified event template may then be renamed such as template_{—}2 and stored in a template database.

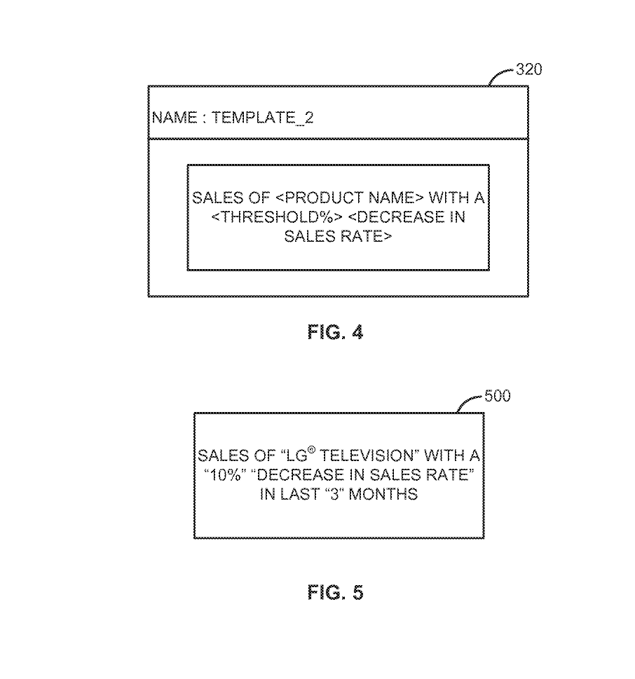

In an embodiment, an existing template may be modified by simply selecting one of the displayed patterns 230 and 340. For example, the template_{—}2, can be modified to include the parameters ‘product name,’ ‘threshold %,’ and ‘decrease in sales rate’ by selecting the pattern 340. In an aspect, by selecting pattern 340, the parameters ‘product name,’ ‘threshold %,’ and ‘decrease in sales rate’ remain in the template_{—}2 while the other parameters (e.g., timeline) are automatically removed. FIG. 4 shows the template_{—}2 as modified based upon the selecting pattern 340. Therefore, by simple clicks or selections the user can easily create any event template. In one embodiment, the user can compose all new content of the new event template in the template area 320.

Once the event template, e.g., 210 is created, the user can provide values of the parameters included in the event template 210 to create the event condition. For example, when the sales manager wants to detect the condition where the sales rate for the LG® television is decreased by 10% in the last three months, the sales manager provides value for the parameters ‘product name’ as ‘LG® television’, ‘threshold %’ as ‘10’ and ‘timeline’ as ‘3.’ In an aspect, a negative threshold % indicates a decrease in threshold value and a positive threshold % indicates an increase in threshold value. Based upon the provided values, the event condition is created. The event monitoring tool 130 (FIG. 1) receives the event condition from the event subscription tool 120. Upon receiving the event condition, the event monitoring tool 130 monitors the business data sources such as reports, databases, analytics tools, etc., to determine whether the event condition is met.

Upon detecting that the event condition is met, the event monitoring tool 130 creates an event trigger. The event trigger along with the event template is sent to the information retrieving tool 110. In one aspect. the event monitoring tool 130 sends the event trigger including a name of the event, e.g., ‘E1.’ In one embodiment, the name of the event may be automatically provided by the event monitoring tool 130. The event monitoring tool 130 may also send the values of the parameters like ‘LG® Television,’ ‘10,’ and ‘3’ for which the event is triggered.

Based upon the received event trigger, the information retrieving tool 110 creates a watchpoint. In one embodiment, the watchpoint may be termed as a search siring pattern. FIG. 5 shows a watchpoint 500 as an example created for the event E1. The watchpoint 500 is created based on the parameters and their corresponding value in the event template 210. As discussed, the watchpoint is the collection of search strings comprising parameters and the values assigned to the parameters in the event template. In an embodiment, the values for some of the parameters in the event template may not be assigned by the user, in such an instance, the missing values are automatically retrieved from the database within the enterprise.

In one embodiment, in addition to using the values assigned to the place holders in the event template, the search strings are formed based on other values from a watchpoint database. The watchpoint database holds a consolidated list of values extracted from several data sources. The additional values used for forming the search strings may be automatically selected from the watchpoint database based on applying heuristics to the event template values. By heuristically determining the association of certain business personnel or product or strategy, with a particular template value, the information retrieving tool 110 (FIG. 1) automatically selects the additional values from the watchpoint database for forming the search strings. For example, the heuristic method may search for values in the watchpoint database that have been frequently linked with the particular value in the past. Alternatively, the heuristic method may search for values in the watchpoint database that have a higher degree of relevance to the particular template value, for example, the proximity of the values to the template value in a hierarchical structure. In an embodiment, the search strings are linked using search operators such as ‘and,’ ‘with,’ ‘next to,’ ‘or,’ etc. Once the information retrieving tool 110 generates the watchpoint for the event ‘E1.’ The generated watchpoint is sent to one or more connectors.

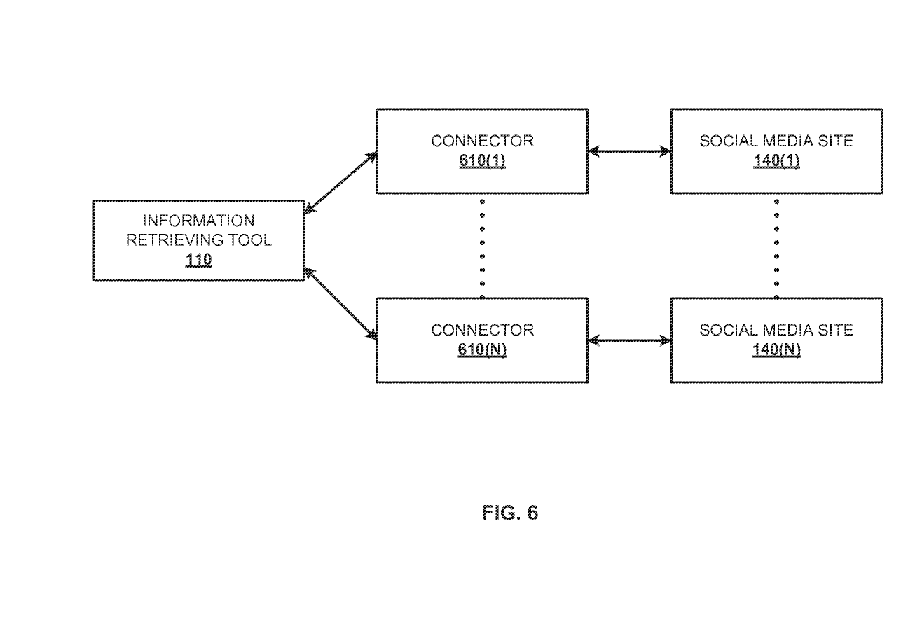

FIG. 6 shows one or more connectors 610(1)-610(N) communicatively coupled to the information retrieving tool 110. In one embodiment, the one or more connectors 610(1)--610(N) are part of the information retrieving tool 110. The one or more connectors 610(1)-610(N) are configured to retrieve information from corresponding one or more social media sites 140(1)-140(N). Once the connectors 610(1)-610(N) receive the watchpoint, the connectors 610(1)-610(N) retrieve the information specified by the watchpoint from their corresponding social media sites 140(1)-140(N). In one embodiment, the connectors 610(1)-610(N) search for the parameters and their corresponding values on their respective social media sites 14(1)-140(N) and retrieve the matching information. In one embodiment, retrieving the information comprises downloading various discussions, feeds, reviews, and comments from the social media sites 140(1)-140(N).

In one embodiment, the information retrieving tool 110 gathers all the information and arranges the gathered information in a predefined format. The arranged information is sent to one or more computing devices. The one or more computing devices may be systems of the process owners. The process owners can then analyze the information. In one embodiment, the user specifies or selects the social media sites 140(1)-140(N), from where the information is to be retrieved, at the time of providing values to the parameters. In one embodiment, the information retrieving tool 110 automatically retrieves the information from the registered social media sites 140(1)-140(N). In one embodiment, the social media sites 140(1)-140(N) gets registered with the information retrieving tool 110 through their respective connectors 610(1)-610(N). For registering a new social media site, a new connector corresponding to the new social media site is installed and configured with the information retrieving tool 110.

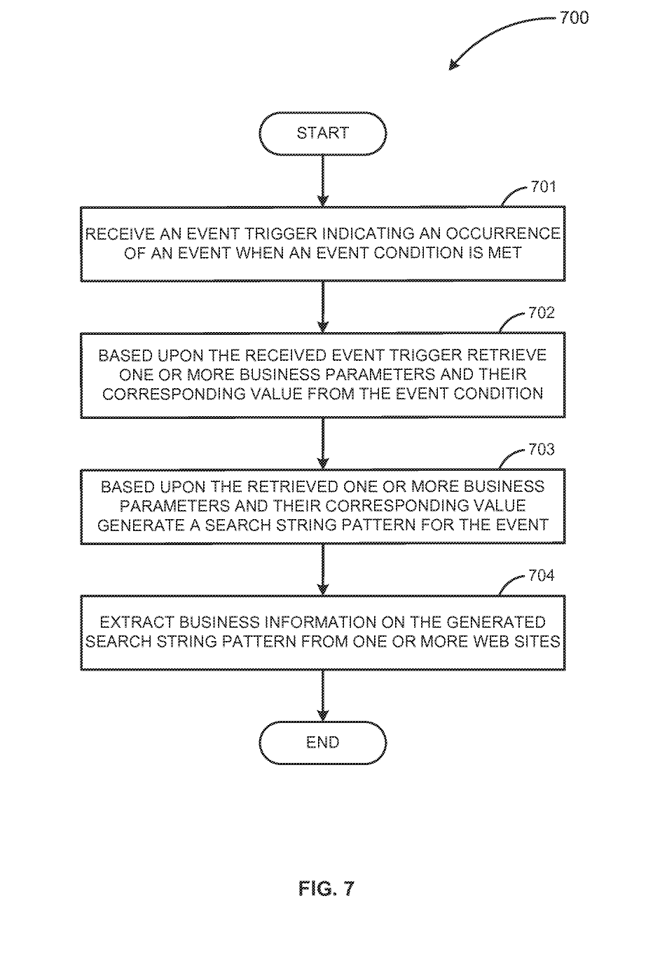

FIG. 7 is a flowchart illustrating process 700 to retrieve information from web sites such as social media sites based upon events in an enterprise, according to an embodiment. An event subscription tool (e.g., event subscription tool 120 of FIG. 1) creates an event condition using an event template. In one embodiment, the event condition is created by assigning values for business parameters or variables in the event template. The created event condition is then provided as input to an event monitoring, tool (e.g., the event monitoring tool 130 of FIG. 1). The event monitoring tool monitors business data sources such as databases, analytics tools, reports, etc., to determine when the event condition is met. Upon detecting that the event condition is met, the event monitoring tool sends an event trigger along with the event condition to an information retrieving tool (e.g., information retrieving tool 110 of FIG. 1). At 701, the information retrieving tool receives the event trigger indicating the occurrence of the event. Based upon the received event trigger, the information retrieving tool retrieves one or more business parameters and their corresponding values from the event condition at 702. In one embodiment, the information retrieving tool also retrieves one or more business parameters from one or more patterns related to the event template and their corresponding values from the enterprise data sources. Based upon the retrieved one or more business parameters and their corresponding values, the information retrieving tool generates a search string pattern (watchpoint) for the event at 703. The information retrieving tool identifies one or more web sites (e.g., social media sites 140(1)-140(N) of FIG. 1) where to look up information matching the generated search string pattern. At 704, the information retrieving tool extracts information based on the search string pattern from the one or more web sites or social media sites.

Embodiments enable enterprises to automatically retrieve relevant information from social media sites. For example, ongoing discussions related to a product can be retrieved automatically from various social media sites. In one embodiment, the information is automatically retrieved upon occurrence of an event in the enterprise. A watchpoint including various keywords related to an event is generated and based upon the generated watchpoint the information on the event is retrieved. In one embodiment, the information is retrieved automatically whenever an event occurs. For example, the information on a product is retrieved automatically when there is a decrease in sales rate of the product. The retrieved information can be analyzed. For example, custom's reviews on the product can be retrieved and analyzed. The analysis helps the enterprise to improve its upcoming products.

In one embodiment, the social media sites from where the information is to be retrieved can be selected. The information is retrieved from the social media sites through connectors corresponding to the social media sites. The enterprise can retrieve information from a new social media site by creating a new connector corresponding to the new social media site. Embodiments also enable capturing and storing event templates and patterns. The stored event templates and patterns can easily be referred or used for creating a new event template. In one embodiment, when the user creates anew event template, the stored event templates and patterns are automatically displayed to the user for reference. Therefore, by simple selections or clicks the user can easily create the new event template.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Sonic example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, CH++, or other object-oriented programming language and development tools. Another embodiment may be implemented in hard-wired circuitry in place of, or in combination with machine readable software instructions.

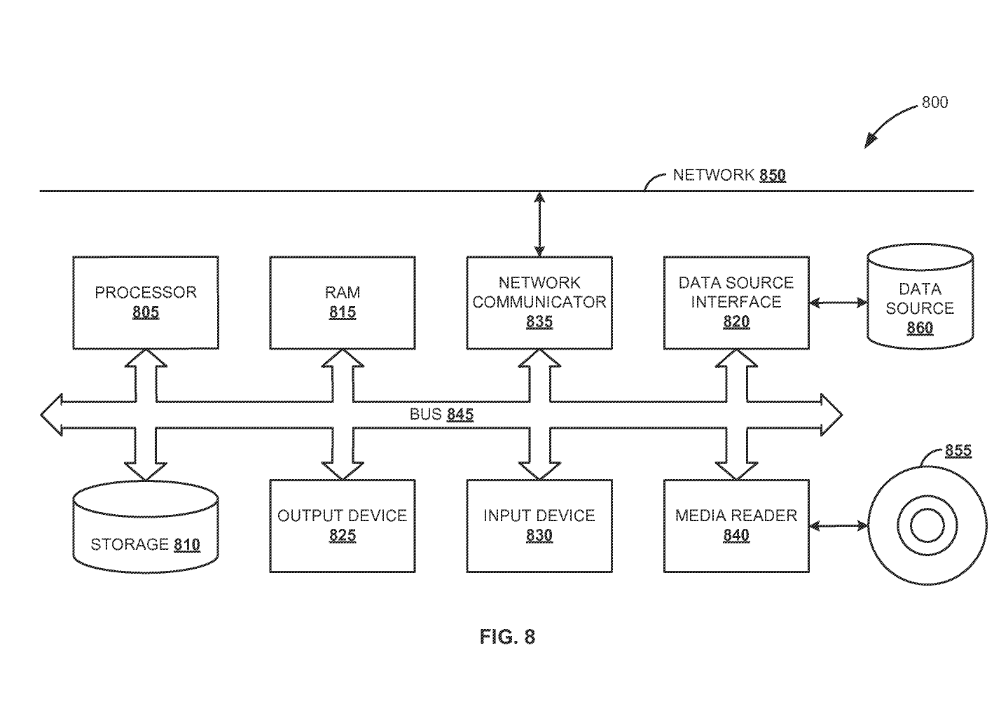

FIG. 8 is a block diagram of an exemplary computer system 800. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, all of the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or More embodiments is to be determined by the following claims, which are to be interpreted in accordance with established doctrines of claim construction.

What is claimed is:

1. A computer-implemented method for extracting information from web sites based upon an event, the method comprising:
receiving an event trigger indicating an occurrence of an event, wherein the event trigger is received when an event condition is met and wherein the event condition characterized by one or more values of one or more parameters of an event template;
based upon the received event trigger, retrieving the one or more parameters and their corresponding one or more values;
based upon at least the retrieved one or more parameters and their corresponding one or more values, generating a search string pattern; and
extracting information based on the generated search string pattern from one or more web sites.

2. The method of claim I further comprising:
arranging the extracted information in a predefined format; and
sending the arranged information to one or more consumers.

3. The method of claim 1, wherein extracting the information comprises downloading at least one of discussions, feeds, reviews, and comments from the one or more web sites.

4. The method of claim I further comprising:
identifying at least one parameter associated with the event and not included in the event condition;
retrieving a value for the identified at least one parameter from a data source; and
adding the retrieved value to the search string pattern.

5. The method of claim 4, wherein the data source is a database or a report.

6. The method of claim I further comprising:
identifying one or more connectors corresponding to the one or more web sites;
sending the generated search string pattern to the identified one or more connectors; and
extracting the information matching the search string pattern from the corresponding one or more web sites through the identified one or more connectors.

7. A computer system for extracting business information from social media sites in response to an event in an enterprise, the system comprising:
at least one memory to store program code; and
at least one processor communicatively coupled to the at least one memory, the at least one processor configured to execute the program code to:
identify an event template having place holders for one or more business parameters;
create an event condition by assigning values to the one or More parameters in the event template;
based upon the values in the event condition, monitor a data source to determine that the event condition is met;
upon determining that the event condition is met, set-off an event trigger;
in response to the event trigger, generate a search string pattern using the values in the event condition; and
extract information from one or more web sites based on the search string pattern.

8. The computer system of claim 7, wherein the at least one processor is further configured to:
identify at least one parameter associated with the event and not included in the event condition;
retrieve a value for the identified at least one parameter from the data source; and
add the retrieved value to the search string pattern.

9. The computer system of claim 7, wherein extracting the information comprises downloading at least one of discussions, feeds, reviews, and comments from the one or more web sites.

10. The computer system f claim 7, wherein the at least one processor is further configured to:
arrange the extracted information in a predefined format; and
send the arranged information to one or more consumers.

11. The computer system of claim 7, wherein he at least one processor is further configured to:
identify one or more connectors corresponding to the one or more web sites;
send the generated search string pattern to the identified one or more connectors; and
extract the information matching the search string pattern from the corresponding one or more web sites through the identified one or More connectors.

12. The computer system of claim 7, wherein the data source is a or a pa

13. An article of manufacture including a non-transitory computer readable storage medium to tangibly store instructions, which when executed cause a computer to:
receive an event trigger indicating an occurrence of an event, wherein the event trigger is received when an event condition is met and wherein the event condition characterized by one or more values of one or more parameters of an event template;
based upon the received event trigger, retrieve the one or more parameters and their corresponding one or more values;
based upon at least the retrieved one or more parameters and their corresponding one or more values, generate a search string pattern; and
extract information based on the generated search string pattern from one or more web sites.

14. The article of manufacture of claim 13, wherein the event trigger is automatically received on occurrence of the event.

15. The article of manufacture of claim 13 further comprising instructions, which when executed cause the computer to:
identify at least one parameter associated with the event and not included in the event condition;
retrieve a value for the identified at least one parameter from a data source; and
add the retrieved value to the search string pattern.

16. The article of manufacture of claim 15, wherein the data source is a database or a report.

17. The article of manufacture of claim 13, wherein extracting the information comprises downloading at least one of discussions, feeds, reviews, and comments from the one or more web sites.

18. The article of manufacture of claim 13 further comprising instructions which when executed cause the computer to:
arrange the extracted information in a predefined format; and
send the arranged information to one or more consumers.

19. The article of manufacture of claim 13 further comprising instructions -which when executed cause the computer to:
identify one or more connectors corresponding to the one or more web sites;
send the generated search string pattern to the identified one or more connectors; and
extract the information matching the search string pattern from the corresponding one or more web sites through the identified one or more connectors.
